(19) United States
(12) Patent Application Publication
(10) Pub. No.: US 2016/0065432 A1
(43) Pub. Date: Mar. 3, 2016

(54) INFORMATION PROCESSING SYSTEM, SETTING STATUS MANAGEMENT METHOD, AND APPARATUS

(71) Applicants: Takao OKAMURA, Tokyo (JP); Hanae Itabashi, Tokyo (JP)

(72) Inventors: Takao OKAMURA, Tokyo (JP); Hanae Itabashi, Tokyo (JP)

(21) Appl. No.: 14/812,409

(22) Filed: Jul. 29, 2015

(30) Foreign Application Priority Data
Aug. 26, 2014 (JP) 2014-171426

(51) Int. Cl. H04L 12/26; H04L 29/06

(52) U.S. Cl. CPC H04L 43/0805; H04L 63/145

(57) ABSTRACT

An information processing system includes a terminal, an apparatus, and a status management apparatus that includes a communication unit, a detection unit that detects network status change via the communication unit, and a notification unit that notifies the apparatus of status change information via the communication unit. The apparatus includes a communication unit, initial configuration information initialized as an operational configuration, a configuration information storing unit that stores changed status configuration information that indicates the operational configuration corresponding to the status change information, a configuration modifying unit that modifies a current operational configuration based on the initial configuration information, the status change information, and the changed status configuration information in the configuration information storing unit after the communication unit receives the status change information, and a control unit that controls one or more operational process executed by the information processing system based on the operational configuration.

### CROSS-REFERENCE TO RELATED APPLICATION

This patent application is based on and claims priority pursuant to 35 U.S.C. §119(a) to Japanese Patent Application No. 2014-171426, filed on Aug. 26, 2014 in the Japan Patent Office, the entire disclosure of which is hereby incorporated by reference herein.

### BACKGROUND

1. Technical Field

The present invention relates to an information processing system, a setting status management method, and an apparatus

2. Background Art

Recently, with the spread of networking, image processing apparatuses such as multifunction peripherals, facsimile machines, copiers, and scanners, and information processing apparatuses such as computers, are connected to each other via networks such as Local Area Networks (LANs) and available for use.

Usually, the networks described above are connected to external networks such as the Internet via routers etc.

That is, in the network systems described above, the network is connected to an external network such as the Internet, and data is exchanged between the external apparatuses, the image processing apparatuses, and the information processing apparatuses on the network. In addition, in the network systems, portable memory devices, etc., such as Universal Serial Bus (USB) memory devices, etc., are inserted into the image processing apparatuses and the information processing apparatuses on the network to exchange data.

In the network systems described above, it is possible that computer viruses infect the image processing apparatuses or the information processing apparatuses on the network intentionally or unintentionally from the external apparatuses connected to the external network or from the portable memory devices.

If the computer viruses infect the network systems described above, it is possible that not only data stored in the image processing apparatuses and the information processing apparatuses on the network is falsified, removed, or deleted but also the network systems are compromised, putting the network system as a whole at risk.

### SUMMARY

An embodiment of the present invention provides a novel information processing system that includes a terminal, an apparatus configured to gain access from the terminal to perform various operational processes, and a status management apparatus. The status management apparatus includes a communication unit that communicates with the terminal and the apparatus via a network, a detection unit that detects network status change including the terminal via the communication unit, and a notification unit that notifies the apparatus of status change information via the communication unit. The apparatus includes a communication unit that communicates with the terminal and the status management unit via the network, initial configuration information initialized as an operational configuration in an operational process, a configuration information storing unit that stores changed status configuration information that indicates the operational configuration corresponding to the status change information reported by the status management apparatus, a configuration modifying unit to modify a current operational configuration based on the initial configuration information, the status change information, and the changed status configuration information in the configuration information storing unit after the communication unit receives the status change information, and a control unit that controls one or more operational process executed by the information processing system based on the operational configuration.

Further embodiments of the present invention provide a setting status management method an apparatus.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as an embodiment of the present invention.

FIG. 2 is a diagram illustrating a table associating a notification level with a changed status configuration as an embodiment of the present invention.

FIG. 3 is a diagram illustrating a software configuration of an image forming apparatus as an embodiment of the present invention.

FIG. 4 is a diagram illustrating functional blocks of the image forming apparatus as an embodiment of the present invention.

FIG. 5 is a schematic diagram illustrating a condition management server, a program server, a client terminal, and a data management server as an embodiment of the present invention.

FIG. 6 is a diagram illustrating a software configuration of the condition management server as an embodiment of the present invention.

FIG. 7 is a block diagram illustrating functions of the condition management server as an embodiment of the present invention.

FIG. 8 is a diagram illustrating a software configuration of the program server as an embodiment of the present invention.

FIG. 9 is a diagram illustrating a program list stored in the program server as an embodiment of the present invention.

FIG. 10 is a diagram illustrating a software configuration of the data management server as an embodiment of the present invention.

FIG. 11 is a flowchart illustrating a process of managing a basic setting status performed by the image forming apparatus as an embodiment of the present invention.

FIG. 12 is a flowchart illustrating an initialization process as an embodiment of the present invention.

FIG. 13 is a flowchart illustrating a process continued from FIG. 12 as an embodiment of the present invention.

FIG. 14 is a diagram illustrating a setting screen for initialization as an embodiment of the present invention.

FIG. 15 is a flowchart illustrating a process of controlling operation as an embodiment of the present invention.

FIG. 16 is a flowchart illustrating a setting process for each status notification level as an embodiment of the present invention.

FIG. 17 is a flowchart illustrating a process for controlling occurrence of access as an embodiment of the present invention.

FIG. 18 is a diagram illustrating a basic operating process in the image processing system as an embodiment of the present invention.

FIG. 19 is a diagram illustrating an operation when access is locked in the image processing system as an embodiment of the present invention.

FIG. 20 is a diagram illustrating an operation when a program is downloaded in the image processing system as an embodiment of the present invention.

FIG. 21 is a diagram illustrating a list of managing downloaded programs as an embodiment of the present invention.

FIG. 22 is a diagram illustrating an operation when a program is downloaded at the top speed in the image processing system as an embodiment of the present invention.

FIG. 23 is a diagram illustrating an operation when a status change notification is not allowed in the image processing system as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

### Embodiment 1

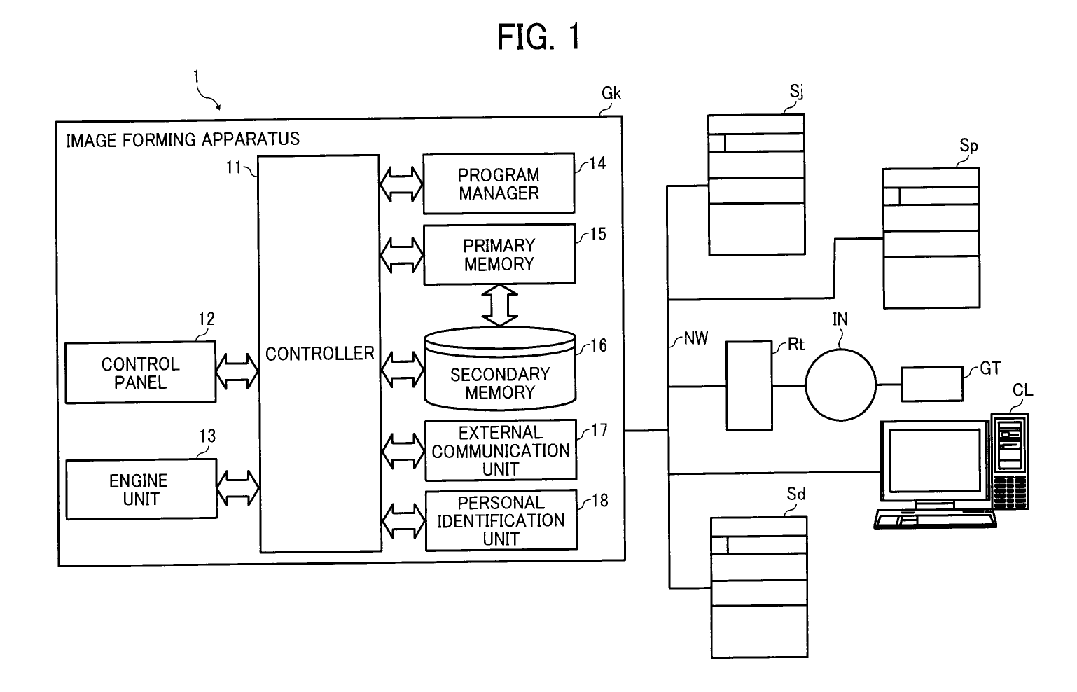

FIGS. 1 to 23 are diagrams illustrating an information processing system and a setting status management method in this embodiment. FIG. 1 is a diagram illustrating an image processing system 1 that adopts an information processing system and a setting status management method in this embodiment.

In FIG. 1, in the image processing system (information processing system) 1, an image forming apparatus Gk, a condition management server Sj, a program server Sp, a client terminal CL, and a data management server Sd etc. are connected to a network NW such as LAN.

The network NW is connected to the Internet IN via a router Rt, and external apparatuses GT such as information processing apparatuses (e.g., computers) and image processing apparatuses (e.g., other image forming apparatuses) are connected to the Internet IN.

In the image processing system 1, the image forming apparatus Gk accepts access from the client terminal CL as a terminal and performs various operational processes, and the condition management server Sj as a condition management apparatus detects change of status of the network NW including the client terminal CL.

Multifunction peripherals etc. are used for the image forming apparatus Gk. While only one image forming apparatus Gk is illustrated in FIG. 1, it is possible that multiple image forming apparatuses Gk are connected to the network NW. After accepting access from the client terminal CL as the terminal, the image forming apparatus Gk performs various operational processes to function as a device.

In accordance with a request for processing operation such as a request for printing requested along with a print job from the client terminal CL, the image forming apparatus Gk performs various image processing such as a print process, scan process, and facsimile process etc.

Image forming apparatus Gk includes a controller 11, a control panel 12, an engine unit 13, a program manager 14, a primary memory 15, a secondary memory 16, an external communication unit 17, and a personal identification unit 18 etc.

The secondary memory 16 includes a hard disk drive and Read Only Memory (ROM) etc. The secondary memory 16 stores an Operating System (OS), basic programs for the image forming apparatus Gk and a setting status management program that the image forming apparatus Gk executes among the setting status management method in this embodiment and corresponding system data. In addition, the secondary memory 16 stores data such as image data and information related to settings etc. that is stored permanently and electronic documents such as information etc.

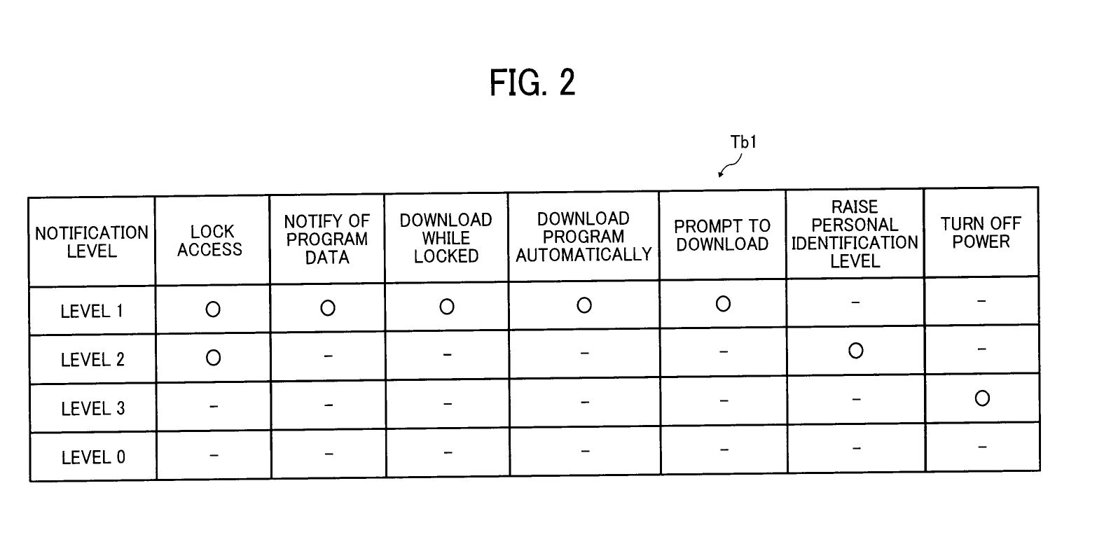

Especially, the secondary memory 16 stores target objects to be blocked in the setting status management method described later and downloaded programs etc. used in the setting status management method described later. The secondary memory 16 stores initial setting information and an association table Tb1 shown in FIG. 2.

In the association table Tb1, for each level (notification level) of status change (change of security status) of a client terminal CL as a terminal that the condition management server Sj reports (described later), change status setting information corresponding to the notification level is registered.

As shown in FIG. 2, in case of security notification, in the association table Tb1, change status settings, i.e., lock access, notify of program data, download while locked, download program automatically, prompt to download, raise personal identification level, and turn off power, are registered.

In the association table Tb1, in accordance with notification levels 1 to 3 and 0, setting changes from initial setting status into one of the change status settings described above are specified. In FIG. 2, in the association table Tb1, change status setting from lock access into prompt to download in notification level 1, change status setting from lock access into raise personal identification level in notification level 2, and change status setting of turn power off are registered.

In addition, in the association table Tb1, no change status setting is registered in notification level 0, and that means the initial settings are restored or the initial settings are maintained.

In the change status setting “lock access” described above, external accesses are rejected. In the change status setting “notify of program data”, programs corresponding to the status change is notified if there is access from the client terminal CL and the control panel 12 is operated by user operation. Examples of the notified programs are anti-virus programs (anti-virus program) and batch of anti-virus programs etc. corresponding to the status change such as the computer viruses etc. Examples of notification method are transferring program information to the client terminal CL, displaying program information on the control panel 12, and recording program information on paper P by the engine unit 13 etc.

In the change status setting “download while locked”, program corresponding to status change during lock that denies external accesses is downloaded.

In the change status setting “download program automatically”, program corresponding to status change is downloaded automatically.

In the change status setting “prompt to download”, notification of prompting program corresponding to the status change is transferred to the client terminal CL that submits the access, displayed on the control panel 12, or output using the engine unit 13.

In the change status setting “raise personal identification level”, personal identification level in a personal identification unit 18 (described later) is raised. For example, in the change status setting “raise personal identification level”, the personal identification level is raised from not performing personal identification to performing the personal identification, and the personal identification level is raised from performing Integrated Circuit (IC) card identification only to requesting to input user password in addition etc.

In the change status setting “turn power off”, power supply to the image forming apparatus Gk is stopped (i.e., the image forming apparatus Gk is turned off).

The primary memory 15 includes Random Access Memory (RAM) etc. and stores various data for image processing and process control performed by the controller 11 temporarily. In addition, the controller 11 uses the primary memory 15 for storing configuration data, status change notification, and program data in the setting status management process in this embodiment temporarily.

The controller 11 includes a Central Processing Unit (CPU) etc. Based on a program stored in the secondary memory 16, the controller 11 uses the primary memory 15 as a work area, control various units in the image forming apparatus Gk, performs a basic operation as the image forming apparatus Gk, and performs the setting status management process in this embodiment.

Especially, after the external communication unit 17 receives the notification of status change information such as detection of computer virus etc., the controller 11 changes the configuration into a setting such as “lock access”, “notify of program data”, “download while locked”, “download program automatically”, “prompt to download”, “raise personal identification level”, and “turn off power” described above.

The control panel 12 includes various operation keys for operating the image forming apparatus Gk along with a display (e.g., a liquid crystal display) and lamps such as Light Emitting Diodes (LEDs).

On the control panel 12, various operations for various image processing using the image forming apparatus Gk and the setting status management process in this embodiment are performed using the operation keys by user operation, and content of commands input using the operation keys and various information notified by the image forming apparatus Gk are displayed on the display in the control panel 12. It is possible that the display in the control panel 12 includes a touch panel. In this case, software keys (function keys) corresponding to various image processing modes are displayed.

Examples of the engine unit 13 are a print engine, a scan engine, and a facsimile engine that perform various image processing.

The print engine performs an image processing that forms (prints) an image on a recording medium such as paper and film etc. (hereinafter referred to as paper accordingly) based on image data using an appropriate printing method (e.g., electrophotographic method and inkjet method etc.).

The scan engine performs an image processing that scans a document in the main scanning direction and the sub-scanning direction to scan an image on the document at predetermined resolution and outputs image data.

The facsimile engine receives facsimile data transferred by a counterpart facsimile machine and forms and outputs an image using the print engine based on the facsimile data. In addition, the facsimile engine faxes the image data of the document that the scan engine scans to the counterpart facsimile machine.

The external communication unit 17 is connected to the network NW, and the external communication unit 17 communicates with various apparatuses via the network NW under the control of the controller 11.

The external communication unit 17 receives status change notification from the condition management server Sj especially and passes the status change notification to the controller 11.

In addition, the external communication unit 17 downloads various programs, especially programs corresponding to status change such as infection by computer virus etc. (e.g., anti-virus program and a batch of anti-virus programs etc.), via the network NW under the control of the controller 11.

Furthermore, the external communication unit 17 accepts access from the client terminal CL and passes content of access such as a print job etc. to the controller 11.

In addition, the external communication unit 17 acquires data stored in the data management server Sd under the control of the controller 11 and passes the data to the controller 11.

The personal identification unit 18 identifies personal identification information for specifying a user of the image forming apparatus Gk. For example, the personal identification unit 18 pre-stores personal identification information such as a user password and identifies the user by determining whether or not the password input on the control panel 12 matches the stored password.

In addition, the personal identification unit 18 includes an IC card reader and identifies a user by determining whether or not personal identification information stored in the IC card that the IC card reader reads corresponds to the pre-stored personal identification information.

By reading the setting status management program that executes a part of the setting status management method that the image forming apparatus Gk is supposed to execute among the setting status management method stored in a computer-readable recording medium such as the ROM, Electrically Erasable and Programmable Read Only Memory (EEPROM), EPROM, flash memory, flexible disc, Compact Disc Read Only Memory (CD-ROM), Compact Disc Rewritable (CD-RW), Digital Versatile Disk (DVD), Universal Serial Bus (USB) memory, Secure Digital (SD) card, and Magneto-Optical (MO) disc etc. and installing the setting status management program on the secondary memory 16 etc., the image forming apparatus Gk is constructed as the apparatus or the image forming apparatus that executes the setting status management method that copes with the status change including security change of the network NW (described later) effectively. The setting status management program is a computer-executable program written in legacy programming languages and object-oriented programming languages such as assembler, C, C++, C#, and Java etc., and the power supply control program can be distributed by storing in the recording medium described above.

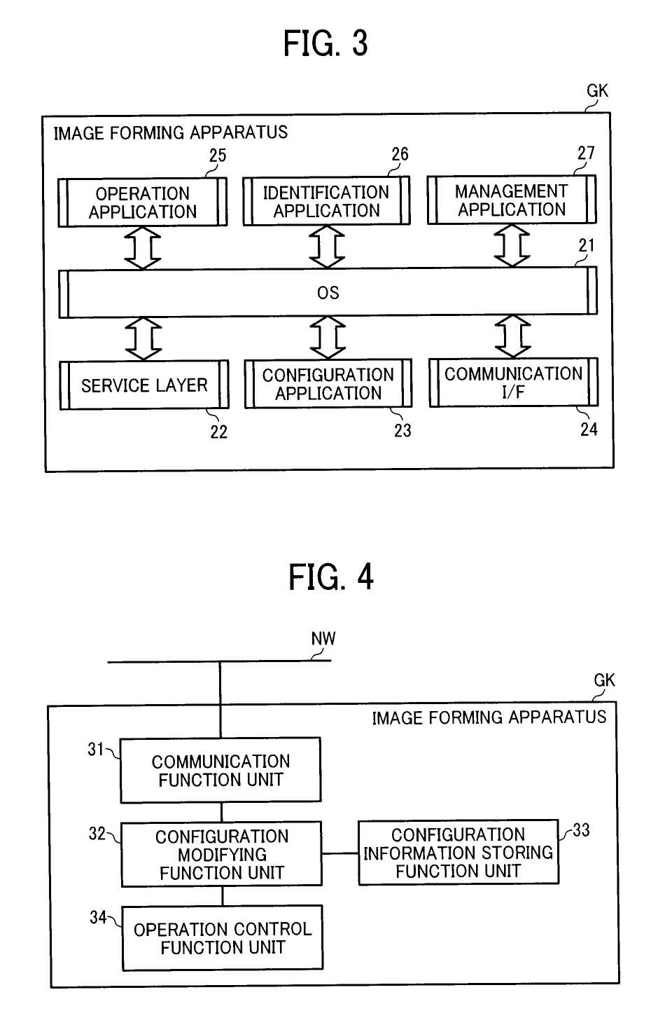

The image forming apparatus Gk includes a software configuration as shown in FIG. 3. That is, the image forming apparatus Gk includes the OS 21, service layer software 22, configuration application 23, communication I/F software 24, operation application 25, identification application 26, and management application 27.

The OS 21 is the operating system of the image forming apparatus Gk. The service layer software 22 runs on the OS 21 to provide interfaces for controlling the primary memory 15 and the secondary memory 16.

The configuration application 23 configures the image apparatus Gk. Based on the notification received from the condition management server Sj via the communication I/F software 24, the configuration application 23 searches through the secondary memory 16 via the OS 21 and the service layer software 22 to modify the settings of the image forming apparatus Gk.

The communication I/F software 24 provides interfaces to communicate with the condition management server Sj, the program server Sp, the client terminal CL, and the data management server Sd via the external communication unit 17.

The operation application 25 is software for controlling the control panel 12, and the operation application 25 expands image data and controls user input operation via the OS 21 and the service layer software 22.

The identification application 26 is software for controlling the personal identification unit 18, and the identification application 26 processes identification data that the personal identification unit 18 acquires via the OS 21 and the service layer software 22 to perform identification process.

The management application 27 is software for controlling the program manager 14, and the management application 27 downloads program from the program server Sp via the communication I/F software 24 through the OS 21 and the service layer software 22. In addition, the management application 27 manages program data stored in the secondary memory 16.

In the image forming apparatus Gk, functional blocks in FIG. 4 are implemented by installing the setting status management program described above. That is, in the image forming apparatus Gk, after installing the setting status management program, functional blocks such as a communication function unit 31, a configuration modifying function unit 32, a configuration information storing function unit 33, and an operation control function unit 34 etc. are implemented.

The communication function unit 31 is implemented by the external communication unit 17, and the communication function unit 31 communicates with the client terminal (terminal) CL and the condition management server (status management apparatus) Sj via the network NW to function as a communication unit.

The configuration information storing function unit 33 is implemented by the secondary memory 16. The configuration information storing function unit 33 stores initial configuration information preset as a setting status in operational processes and change status configuration information that indicates setting statuses in accordance with status change information that the condition management server Sj reports to function as a configuration information storing unit. That is, the configuration information storing function unit 33 stores initial configuration information that the image forming apparatus Gk can operate as the setting status in the notification level 0 in FIG. 2 and change status configuration information as settings in the notification levels 1 to 3. In addition, the configuration information storing function unit 33 stores program acquisition prompt configuration information that indicates a prompting operation to acquire an anti-virus program corresponding to virus as the change status configuration information.

The configuration modifying function unit 32 is implemented by the controller 11. After the communication function unit 31 receives the status change information, the configuration modifying function unit 32 modifies current operating configuration based on the change status configuration information that corresponds to the initial configuration information and the status change information in the configuration information storing function unit 33 to function as a configuration modifying unit. In addition, the configuration modifying function unit 32 modifies the operating settings to notify the client terminal CL that performs accessing about being infected by virus and to prompt to acquire the anti-virus program based on virus infection information in the initial configuration information and the status modifying information and the program acquisition prompt configuration information as the change status configuration information in the configuration information storing function unit 33.

The operation control function unit 34 is implemented by the controller 11, and the operation control function unit 34 controls operating processes of the image forming apparatus based on the operating configuration to function as an control unit.

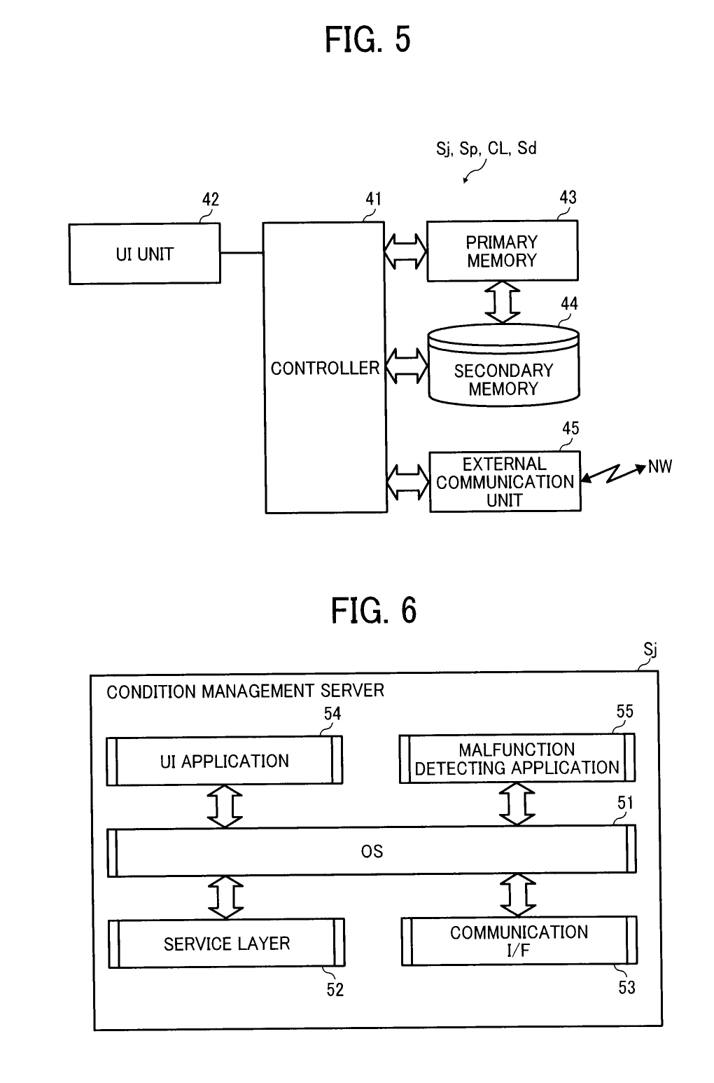

Computers etc. are used for the condition management server Sj, the program server Sp, the client terminal CL, and the data management server Sd, and they have block configurations as shown in FIG. 5 schematically. That is, as shown in FIG. 5, the condition management server Sj, the program server Sp, the client terminal CL, and the data management server Sd include a controller 41, a UI unit 42, a primary memory 43, a secondary memory 44, and an external communication unit 45 etc.

The secondary memory 44 includes nonvolatile memory devices such as hard disk drives and stores operating systems for the condition management server Sj, the program server Sp, the client terminal CL, and the data management server Sd and various data.

The primary memory 43 includes the RAM etc., and the primary memory 43 is used as work memory of the controller 41 to store processing data temporarily.

The controller 41 includes the CPU etc. and controls various units in the condition management server Sj, the program server Sp, the client terminal CL, and the data management server Sd using the primary memory as the work memory based on the programs stored in the secondary memory 44. By controlling the various units in the condition management server Sj, the program server Sp, the client terminal CL, and the data management server Sd, the controller 41 performs processes as the condition management server Sj, the program server Sp, the client terminal CL, and the data management server Sd.

The UI unit 42 includes input devices such as a keyboard and mouse etc., and output devices such as a display etc., and the UI unit 42 inputs/outputs data into/from the condition management server Sj, the program server Sp, the client terminal CL, and the data management server Sd.

The external communication unit 45 is connected to the network NW, and the external communication unit 45 communicates with other apparatuses, especially the image forming apparatus Gk, via the network NW under the control of the controller 41.

By reading a setting status management program that performs a part of the setting status management method executed by the condition management server Sj among setting status management methods in this embodiment stored in a computer-readable recording medium such as the ROM, EEPROM, EPROM, flash memory, flexible disk, CD-ROM, CD-RW, DVD, USB memory, SD card, and MO and installing the setting status management program in the secondary memory 44 etc., the condition management server Sj is implemented as the status management apparatus that executes the setting status management method that copes with status change of the network NW including security (described later) effectively. The setting status management program is a computer-executable program written in legacy programming languages and object-oriented programming languages such as assembler, C, C++, C#, and Java etc., and the power supply control program can be distributed by storing in the recording medium described above.

As shown in FIG. 6, the condition management server Sj includes a software configuration to include an OS 51, a service layer software 52, a communication I/F software 53, an UI application 54, and a malfunction detecting application 55.

The OS 51 is the operating system of the condition management server Sj. The service layer software 52 runs on the OS 51 to provide interfaces for controlling the primary memory 43 and the secondary memory 44.

The communication I/F software 53 provides interfaces to communicate with apparatuses, especially the client terminal CL and the image forming apparatus Gk, via the external communication unit 45.

The UI application 54 is software for controlling the UI unit 42, and the UI application 54 processes data and controls user input operation via the OS 51 and the service layer software 52.

The malfunction detecting application 55 detects status change on the network NW, especially status change of the external apparatuses such as the client terminal CL etc. (e.g., whether or not malfunction status exists etc.) via the communication I/F 53 and notifies the image forming apparatus Gk about the detecting result. The malfunction detecting application 55 detects the status change, especially security status change that the client terminal CL is infected by computer virus etc., and notifies the image forming apparatus Gk about the detecting result.

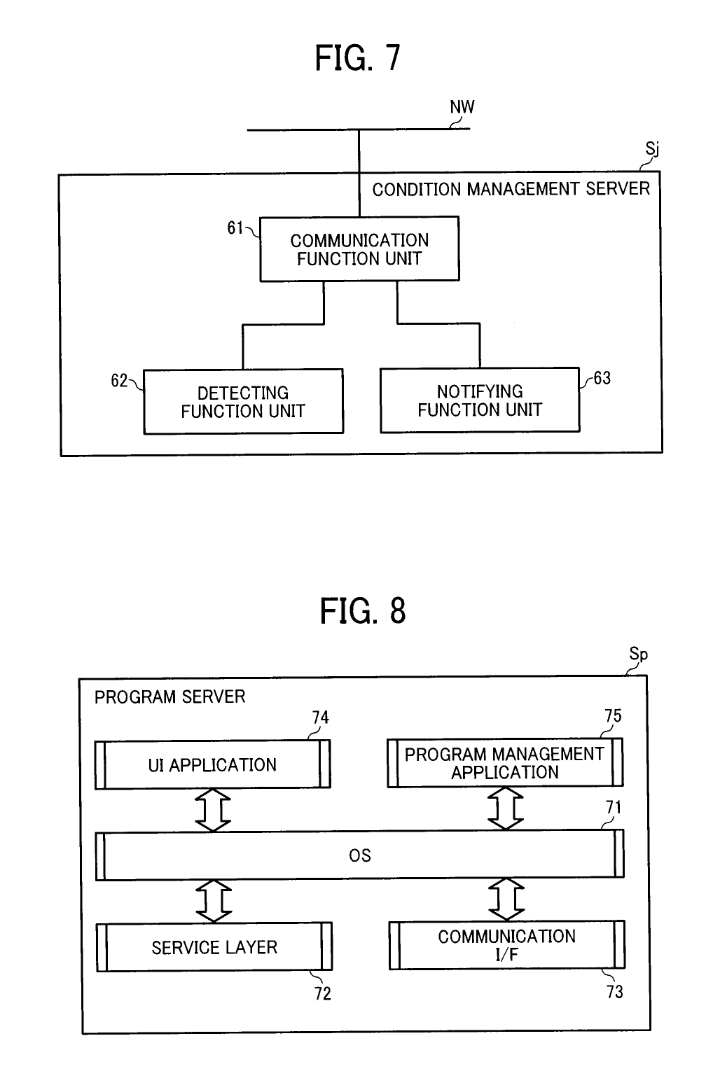

In the condition management server Sj, functional blocks in FIG. 7 are implemented by installing the setting status management program described above. That is, by installing the setting status management program, in the condition management server Sj, a communication function unit 61, a detecting function unit 62, and a notifying function unit 63 etc. are implemented.

The communication function unit 61 is implemented by the external communication unit 45. The communication function unit 61 communicates with the client terminal CL as the terminal and the image forming apparatus Gk as the apparatus to function as a communication unit.

The detecting function unit 62 is implemented by the controller 41. The detecting function unit 62 detects the security status change (status change) of the client terminal CL via the communication function unit 61 to function as a detection unit.

The notifying function unit 63 is implemented by the controller 41 etc., and the notifying function unit 63 notifies the image forming apparatus Gk about the status change information described above via the communication function unit 61 to function as a notification unit.

For example, the notifying function unit 63 notifies the image forming apparatus Gk about the status change detected by the detecting function unit 62 changing the notification level into the notification level 0 to 3 depending on its degree, such as degree of virus threat.

As shown in FIG. 8, the program server Sp includes a software configuration and includes an OS 71, a service layer software 72, a communication I/F software 73, an UI application 74, and a program management application 75 etc.

The OS 71 is the operating system of the program server Sp. The service layer software 72 runs on the OS 71 to provide interfaces for controlling the primary memory 43 and the secondary memory 44.

The communication I/F software 73 provides interfaces to communicate with apparatuses, especially the client terminal CL and the image forming apparatus Gk, via the external communication unit 45.

The UI application 74 is software for controlling the UI unit 42, and the UI application 74 processes data and controls user input operation via the OS 71 and the service layer software 72.

The program management application 75 checks a program request (status change notification) from external apparatuses on the network NW, especially the client terminal CL and the image forming apparatus Gk. If there is the program request along with the status change notification, the program management application 75 downloads a desired program from the external apparatus. The program management application 75 manages the downloaded programs and provides the programs via the communication I/F software 73 in response to the request from the client terminal CL and the image forming apparatus Gk.

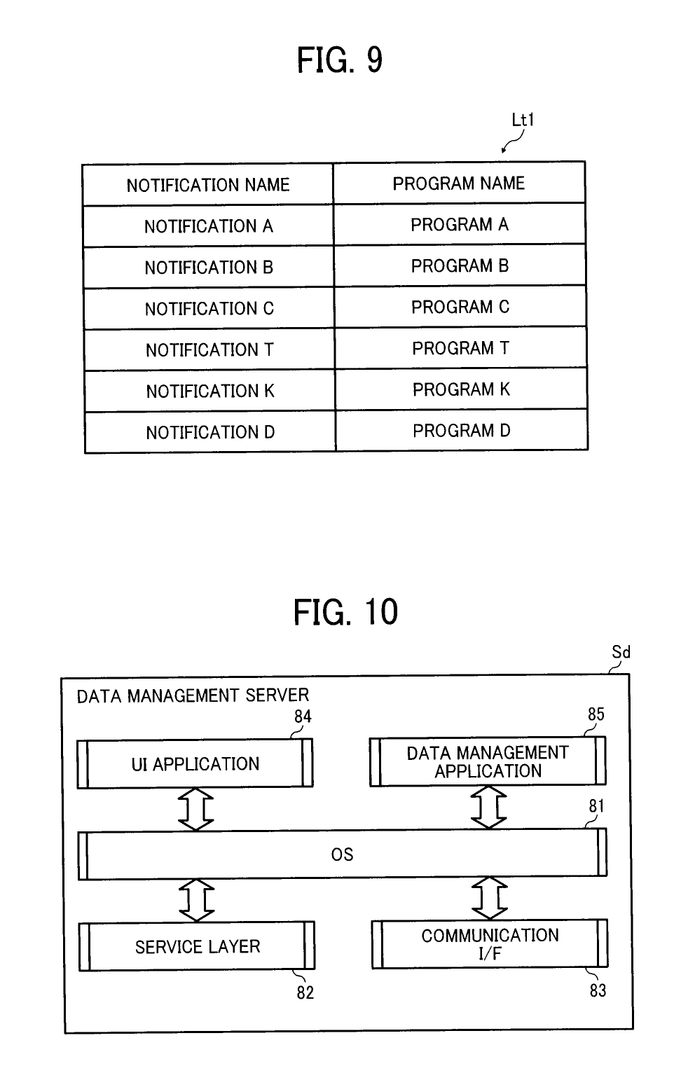

For example, the program management application 75 includes a program list Lt1 as shown in FIG. 9. As shown in FIG. 9, in the program list Lt1, program names corresponding to status change notifications are registered. For example, “program A” is registered in accordance with “notification A”.

If “notification A” is received as the status change notification, the program management application 75 downloads “program A” from its vendor, stores “program A”, and provides “program A” in response to the request from the client terminal CL and the image forming apparatus Gk.

As shown in FIG. 10, the data management server Sd includes a software configuration and includes an OS 81, a service layer software 82, a communication I/F software 83, an UI application 84, and a data management application 85 etc.

The OS 81 is the operating system of the data management server Sd. The service layer software 82 runs on the OS 81 to provide interfaces for controlling the primary memory 43 and the secondary memory 44.

The communication I/F software 83 provides interfaces to communicate with apparatuses, especially the client terminal CL and the image forming apparatus Gk, via the external communication unit 45.

The UI application 84 is software for controlling the UI unit 42, and the UI application 84 processes data and controls user input operation via the OS 71 and the service layer software 82.

If there is the data request from external apparatuses on the network NW, especially the client terminal CL and the image forming apparatus Gk, the data management application 85 downloads data and provides requested data.

Next, workings in this embodiment are described below. The image processing system 1 in this embodiment copes with status change of the network NW including security effectively.

That is, in the image processing system 1, the image forming apparatus Gk, the condition management server Sj, the program server Sp, the client terminal CL, and the data management server Sd etc. are connected to a network NW. The condition management server Sj monitors status change of terminals on the network NW, especially status change of the client terminal CL including security. If there is status change (e.g., the terminal is infected by computer virus), the condition management server Sj notifies the image forming apparatus Gk about the status change. In response to the status change, the image forming apparatus Gk modifies the operating configuration of the image forming apparatus Gk in accordance with the status change to cope with the status change effectively.

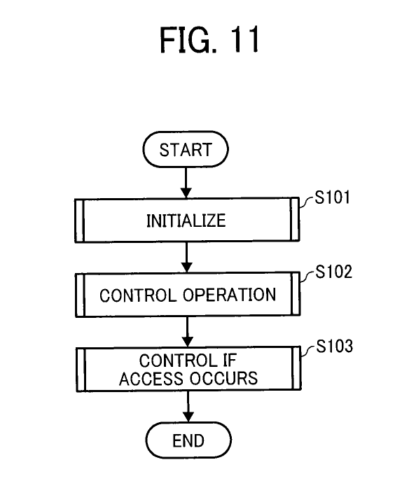

First, a basic setting status management process of the image forming apparatus Gk is described below with reference to FIG. 11.

As shown in FIG. 11, in the image forming apparatus Gk, the controller 11 first performs an initialization process in S101. In the initialization process, setting status in the setting status management process is initialized (described later in detail).

Next, the controller 11 performs an operating control process in accordance with the initialization process in S102 and performs an accessing control process in accordance with the initialization process in S103. The image forming apparatus Gk performs the operating control process in accordance with the configuration in the initialization process in case of receiving the status change notification from the condition management server Sj. The image forming apparatus Gk performs the accessing control process if the client terminal CL accesses the image forming apparatus Gk.

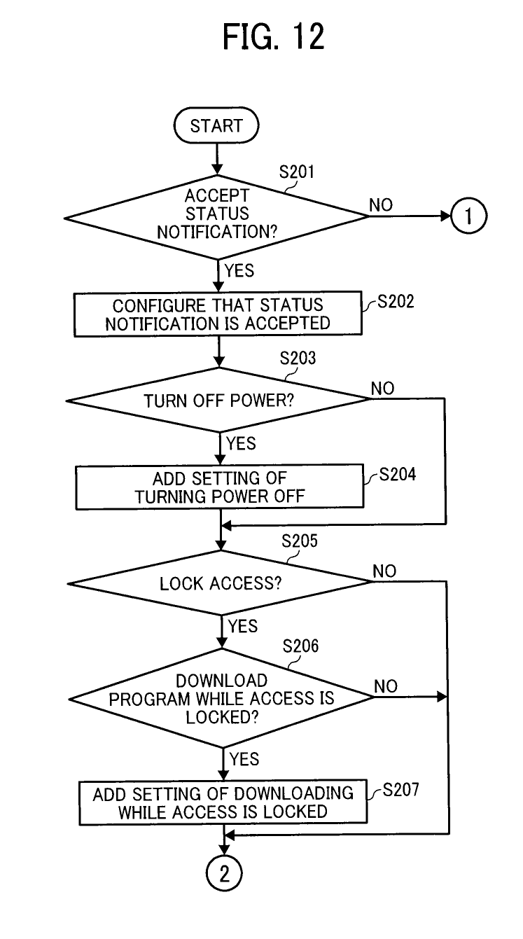

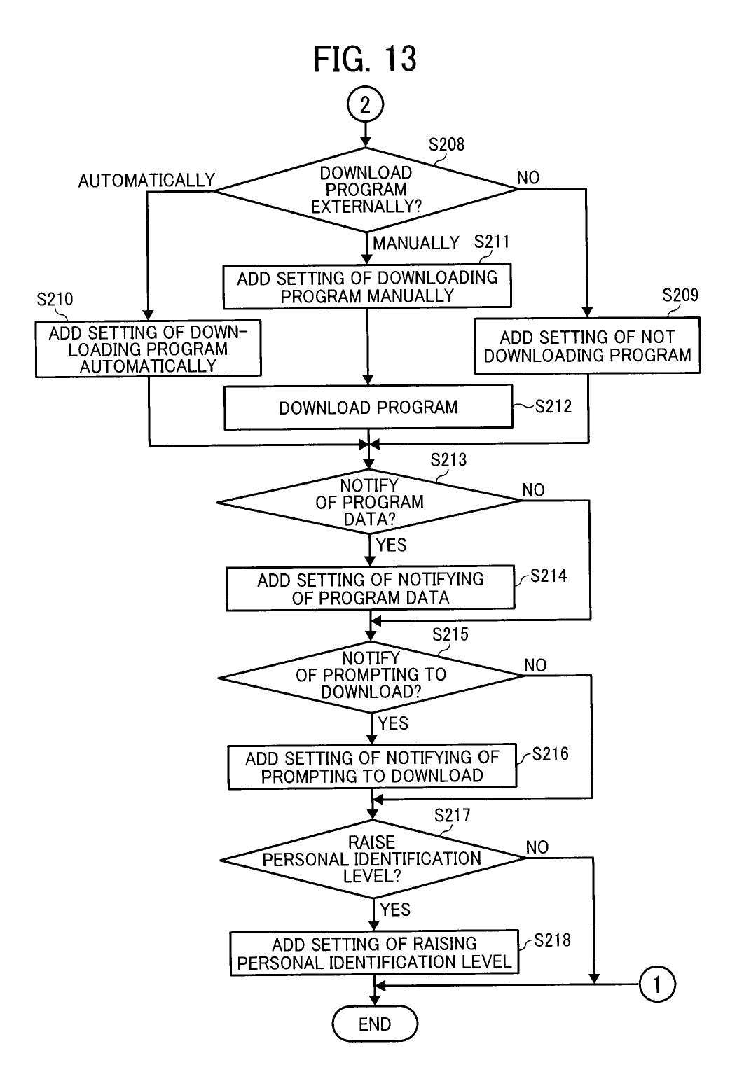

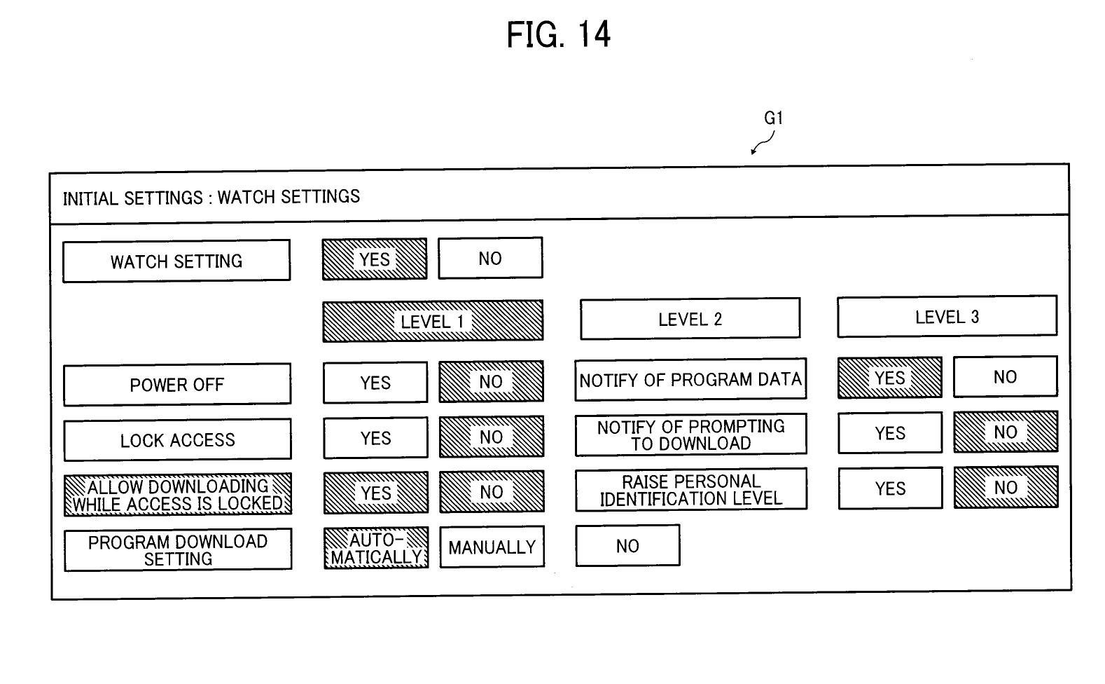

Accordingly, the image forming apparatus Gk performs the initialization process described above as shown in FIGS. 12 and 13.

In the initialization process, for example, the image forming apparatus Gk displays an initialization configuration screen G1 in FIG. 14 on a display of the control panel 12 in the image forming apparatus Gk to accept initialization settings by user/administrator operation.

In FIG. 14, by selecting “yes” for “watch setting”, the status change notification from the condition management server Sj is received, and by selecting “no” for “watch setting”, the status change notification from the condition management server Sj is not received.

In FIG. 14, in the initialization setting in response to the status change notification from the condition management server Sj, setting are configured for each of levels 1 to 3. Examples of the setting item are “power off”, “lock access”, “allow downloading while access is locked”, “program download setting”, “notify of program data”, “notify of prompting to download”, and “raise personal identification level”, and the setting are not limited to them. In the notification level 0, if current settings are initial settings, the current settings are maintained. If the current settings are modified, the modified settings are canceled, and the initial settings are recovered.

That is, after starting the initialization process, as shown in FIG. 12, the controller 11 first checks whether or not the configuration that accepts the status change notification from the condition management server Sj is selected in S201.

If the configuration that does not accept the status change notification is selected (NO in S201), the controller 11 determines that it is unnecessary to perform the configuration process described below, and the initialization process ends as shown in FIG. 13.

If the configuration that accepts the status change notification is selected (YES in S201), the controller modifies the configuration to accept the status change notification in S202 and checks whether or not the configuration that turns off power (“power off” setting) is selected in S203. In the “power off” setting, if the status change notification corresponding to that level is received from the condition management server Sj, the image forming apparatus Gk is turned off.

In S203, if the “power off” setting is selected (YES in S203), the controller 11 adds the “power off” setting to the initial settings in S204 and checks whether or not the “lock access” setting is selected in S205.

In S203, if the “power off” setting is not selected (NO in S203), the controller 11 checks whether or not the “lock access” setting is selected in S205 without configuring the “power off” setting. In the “lock access” setting, accesses from other apparatuses such as the client terminal CL etc. are locked (rejected).

In S205, if the “lock access” setting is selected (YES in S205), the controller 11 checks whether or not the “download program” setting that downloads a program even if the access is locked is selected in S206. In the “download program” setting, programs corresponding to the status change notification are downloaded, e.g., in case of the virus infection notification, programs such as anti-virus programs for removing the virus are downloaded.

In S206, if the “download program” in case of locking accesses is selected (YES in S206), the controller 11 adds the configuration that downloads programs even in case of locking accesses. As shown in FIG. 13, the controller 11 checks whether or not programs are downloaded externally in S208.

In S208, if the “download program” externally is not selected (NO in S208), the controller adds the configuration that does not download programs to the initial settings in S209.

If the program is downloaded externally automatically (AUTOMATICALLY in S208), the controller 11 adds the configuration that downloads programs automatically to the initial settings in S210.

If the program is downloaded externally manually (MANUALLY in S208), the controller 11 adds the configuration that downloads programs manually to the initial settings in S211. After setting “download manually”, the controller 11 downloads a program specified by user operation from an external apparatus that provides the program and stores it in the secondary memory 16 in S212.

After configuring “download program”, the controller 11 checks whether or not data related to the program corresponding to the status change notification is reported in S213.

In S213, if the setting that notifies of program data is selected (YES in S213), the controller 11 adds the configuration that notifies of program data to the initial settings in S214. The controller 11 checks whether or not a prompt to download is notified in S215.

In S213, if the setting that does not notify of program data is selected (NO in S213), the controller 11 checks whether or not a prompt to download is notified without configuring the setting that notifies of program data in S215. Examples of the notification of prompting download are displaying notification of prompting to download a program corresponding to the status change notification on the display of the control panel 12 in the image forming apparatus Gk, outputting the notification on recording sheet using the engine unit 13, and sending a message reporting the notification to the client terminal CL etc.

In S215, if the setting that notifies of prompting to download is selected (YES in S215), the configuration that notifies of prompting to download is added to the initial settings in S211, and it is checked whether or not a personal identification level is raised in S217. In S215, if the setting that notifies of prompting to download is not selected (NO in S215), the configuration that notifies of prompting to download is not added to the initial settings, and it is checked whether or not a personal identification level is raised in S217. For example, if the personal identification is not configured, it is desired to perform the personal identification by raising the personal identification level. If IC card identification is a basic identification, it is requested to input password using the control panel 12 by raising the personal identification level.

In S217, if the configuration that raises the personal identification level is selected (YES in S217), the controller 11 adds the configuration that raises the personal identification level to the initial settings in S218, and the initialization process ends.

In S217, if the configuration that raises the personal identification level is not selected (NO in S217), the controller 11 does not add the configuration that raises the personal identification level to the initial settings, and the initialization process ends.

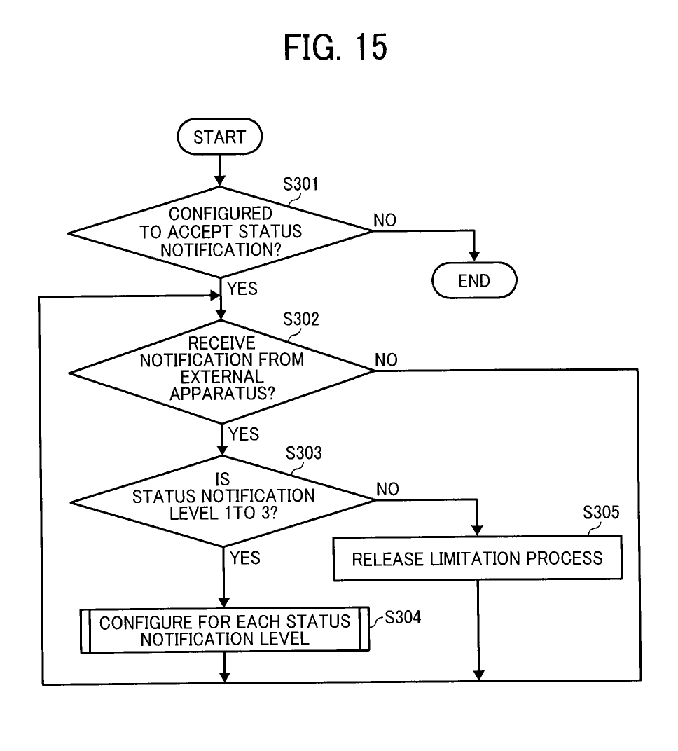

Next, after finishing the initialization process and configuring the additional settings etc. corresponding to the status change notification on the initial settings, the controller 11 performs an operating control process as shown in FIG. 15.

That is, after the image forming apparatus Gk starts by turning on power etc., the controller 11 first acquires settings of the status management and checks whether or not the status change notification from the condition management server Sj is received in S301.

In S301, if the configuration that accepts the status change notification is not selected (NO in S301), the controller 11 determines that it is unnecessary to perform the operating control process, and the process ends.

In S301, if the configuration that accepts the status change notification is selected (YES in S301), the controller 11 checks whether or not the status change notification is received from the condition management server Sj as the external apparatus in S302.

In S302, if the status change notification is not received from the condition management server Sj (NO in S302), the controller 11 checks whether or not the status change notification is received again after predetermined period of time in S302. That is, the controller 11 checks whether or not the status change notification is received from the condition management server Sj in every predetermined period of time.

In S302, if the status change notification is received from the condition management server Sj (YES in S302), the controller 11 checks which notification level 1 to 3 is received as the status notification level in S303.

If the status notification level corresponds to any one of notification level 1 to 3 (YES in S303), the controller 11 performs a configuration process in accordance with the status notification level in S304. Subsequently, the process returns to S302, and the controller 11 performs the steps S302 to S304 similarly as described above.

In S303, if the status notification level does not corresponds to any one of notification level 1 to 3, i.e., the status notification level corresponds to notification level 0 (NO in S303), the controller 11 releases modification of settings (limitation process) in S305. Subsequently, the process returns to S302, and the controller 11 performs the steps S302 to S305 similarly as described above.

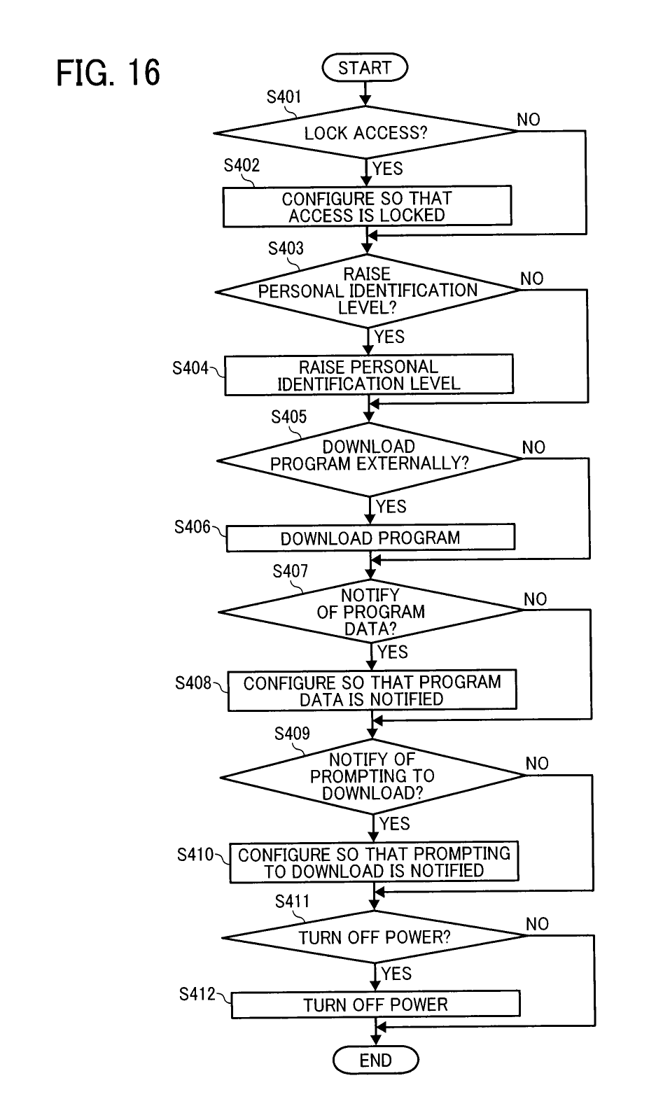

Next, the controller 11 performs a configuration process for each status notification level in S304 described above as shown in FIG. 16.

That is, first, the controller 11 checks whether or not accesses are to be locked in S401. In locking accesses, the controller 11 rejects not only accesses to the image forming apparatus Gk by the client terminal CL but also accesses to the data management server Sd through the image forming apparatus Gk.

In S401, if accesses are locked (YES in S401), the controller 11 changes the setting into “lock access” in S402 and checks whether or not the personal identification level is to be raised in S403.

In S401, if accesses are not locked (NO in S401), the controller 11 does not change the setting into “lock access” and checks whether or not the personal identification level is to be raised in S403.

In S403, if the personal identification level is to be raised (YES in S403), the controller 11 raises the personal identification level in S404 and checks whether or not programs are downloaded externally in S405. That is, the controller 11 checks whether or not a program is to be downloaded from the program server Sp.

In S405, if the program is to be downloaded externally (YES in S405), the controller 11 downloads the program in S406 and checks whether or not program data is to be notified in S407.

In S405, if the program is not to be downloaded externally (NO in S405), the controller 11 does not download the program and checks whether or not program data is to be notified in S407.

In S407, if the program data is to be notified (YES in S407), the controller 11 configures the setting to notify of program data in S408 and checks whether or not a prompt for downloading is to be notified in S408.

In S407, if the program data is not to be notified (NO in S407), the controller 11 does not configure the setting to notify of program data and checks whether or not a prompt for downloading is to be notified in S409.

In S409, if the prompt for downloading is to be notified (YES in S409), the controller 11 configures the setting to notify of prompt to download in S410 and checks whether or not power is to be turned off in S411.

In S409, if the prompt for downloading is not to be notified (NO in S409), the controller 11 does not configure the setting to notify of prompt to download and checks whether or not power is to be turned off in S411.

In S411, if power is to be turned off (YES in S411), the controller 11 turns the image forming apparatus Gk off in S412, and the configuration process for each of status notification level ends.

In S411, if power is not to be turned off (NO in S411), the controller 11 does not turn the image forming apparatus Gk off, and the configuration process for each of status notification level ends.

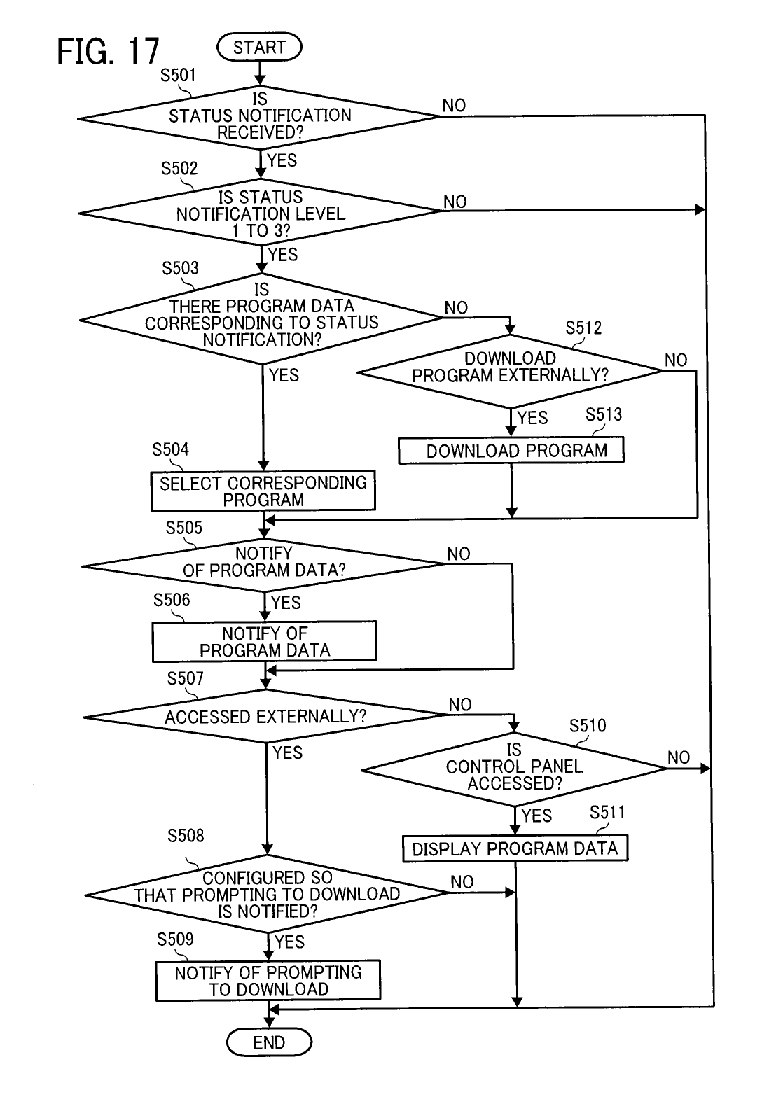

Next, as shown in FIG. 17, the controller 11 performs an access occurrence control process in FIG. 11.

That is, the controller 11 checks whether or not the status change notification is received in S501. If the status change notification is not received (NO in S501), the controller 11 determines that it is unnecessary to perform the access occurrence control process, and the process ends.

In S501, if the status change notification is received (YES in S501), it is checked whether or not the status notification level corresponds to any one of notification levels 1 to 3 in S502.

In S502, if the status notification level corresponds to notification level 0 other than any one of notification levels 1 to 3, the process ends.

In S502, if the status notification level corresponds to any one of notification level 1 to 3 (YES in S502), it is checked whether or not program data corresponding to the status change notification exists in S503.

In S503, if the program data corresponding to the status change notification exists (YES in S503), the controller 11 selects the corresponding program in S504 and checks whether or not the program data is to be notified in S505.

In S503, if the program data corresponding to the status change notification does not exist (NO in S503), the controller 11 checks whether or not program is downloaded from the program server Sp externally in S512.

In S512, if the program is downloaded from the program server Sp (YES in S512), the controller 11 downloads the corresponding program in S513. After downloading the program, the controller 11 checks whether or not the program data is to be notified in S505. In S512, if the program is not downloaded from the program server Sp (NO in S512), the controller 11 checks whether or not the program data is to be notified in S505.

In S505, if the program data is to be notified (YES in S505), the controller 11 notifies of the program data in S506. After notifying of the program data, the controller 11 checks whether or not access occurs externally, i.e., there is access from the client terminal CL, in S507.

In S505, if the program data is not to be notified (NO in S505), the controller 11 does not notify of the program data and checks whether or not there is access from the client terminal CL in S507.

In S507, if there is access from the client terminal CL (YES in S507), the controller 11 checks whether or not notification of prompting to download is set in S508.

In S508, if the notification of prompting to download is set (YES in S508), the controller 11 notifies of prompting to download in S509, and the access occurrence control process ends.

In S508, if the notification of prompting to download is not set (NO in S508), the controller 11 does not notify of prompting to download, and the access occurrence control process ends.

In S507, if there is no access from the client terminal CL (NO in S507), the controller 11 checks whether or not there is access from the control panel 12 in S510.

In S510, if there is access from the control panel 12 (YES in S510), the controller 11 displays the program data on the display of the control panel 12 in S511, and the access occurrence control process ends.

In S510, if there is no access from the control panel 12 (NO in S510), the controller 11 finishes the access occurrence control process as is.

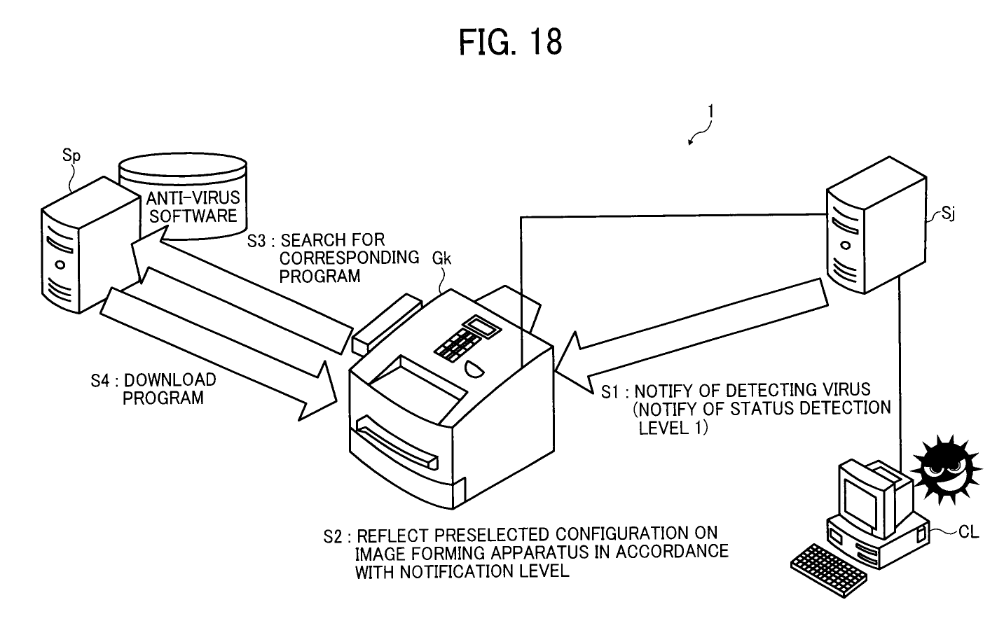

That is, as shown in FIG. 18, in the image processing system 1, the condition management server Sj monitors each terminal on the network NW, especially the condition management server Sj monitors status change of the client terminal CL including security. If there is status change such as infection by computer virus, the condition management server Sj notifies the image forming apparatus Gk about the status change notification accordingly and its status notification level (any one of notification levels 1 to 3) in S1.

In response to the status change, in the image forming apparatus Gk, the image forming apparatus Gk is configured with a preselected operational configuration in accordance with the status change in S2.

In addition, in accordance with the configuration in the initialization process, the image forming apparatus Gk searches for a program corresponding to the status change such as anti-virus program etc. through the program server Sp in S3, and the program is downloaded from the program server Sp in S4.

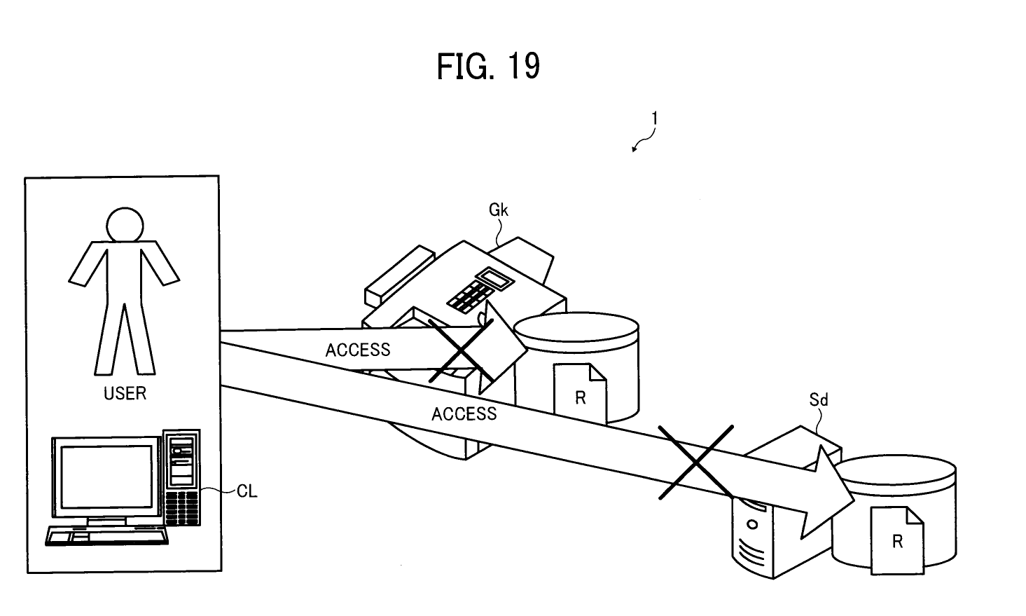

As shown in FIG. 19, in the image processing system 1, if the image forming apparatus Gk is configured so that access is rejected in the initialization process and there is the status change notification of detecting computer virus from the condition management server Sj, access from the client terminal CL by user operation is rejected. In this case, the image forming apparatus Gk not only rejects the client terminal CL's access to data in the image forming apparatus Gk but also requests other terminals (e.g., the data management server Sd) to lock so that access to data in the data management server Sd is rejected.

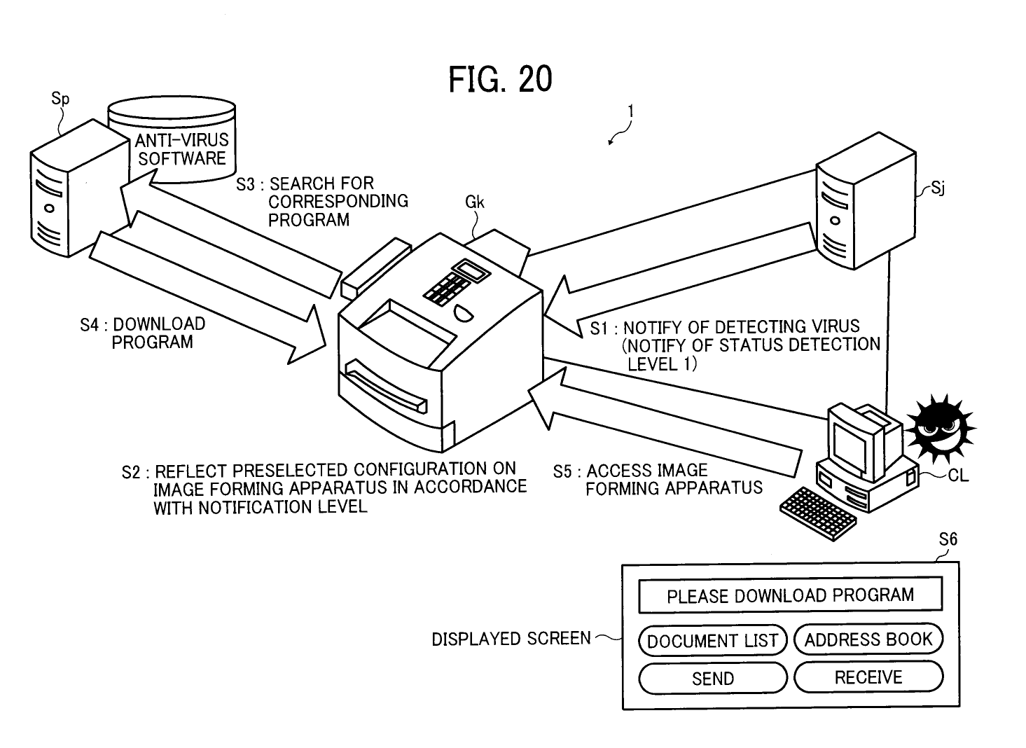

Furthermore, in the image processing system 1, if the image forming apparatus Gk is configured to notify of downloading a program and the condition management server Sj detects computer virus as shown in FIG. 20, the image forming apparatus Gk is notified of the status change notification of detecting the computer virus in S1. In FIG. 20, it should be noted that same numbers are assigned to processes same as in FIG. 17.

In response to the status change, in the image forming apparatus Gk, the image forming apparatus Gk is configured with a preselected operational configuration in accordance with the status change in S2.

In addition, in accordance with the configuration in the initialization process, the image forming apparatus Gk searches for a program corresponding to the status change such as anti-virus program etc. through the program server Sp in S3, and the program is downloaded from the program server Sp in S4.

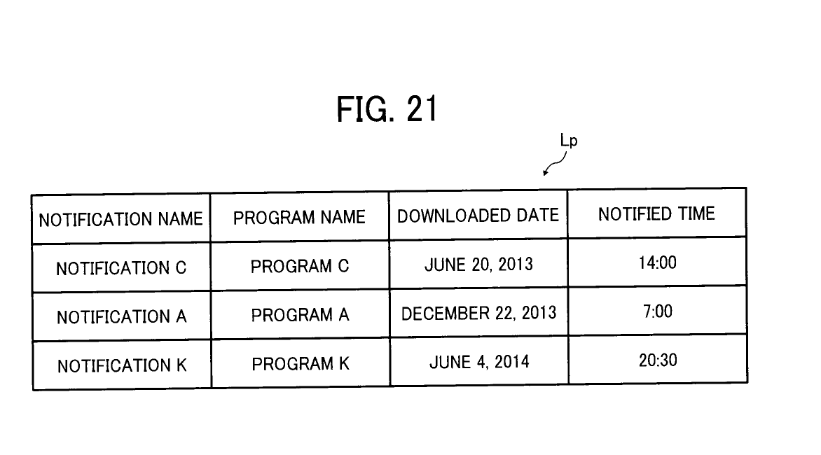

Next, in the image forming apparatus Gk, the downloaded program is stored as a program management list Lp as shown in FIG. 21 in the secondary memory 16. In the program management list Lp, program name, download history, and notification history are stored in association with notification name.

After that, if there is access from the client terminal CL in S5, the image forming apparatus Gk notifies of downloading a program and displays a screen that indicates messages such as “Please download program” etc. on the display of the client terminal CL to attract user attention.

After notifying of downloading the program, the image forming apparatus Gk registers notifying time in the notification history in the program management list Lp in FIG. 21.

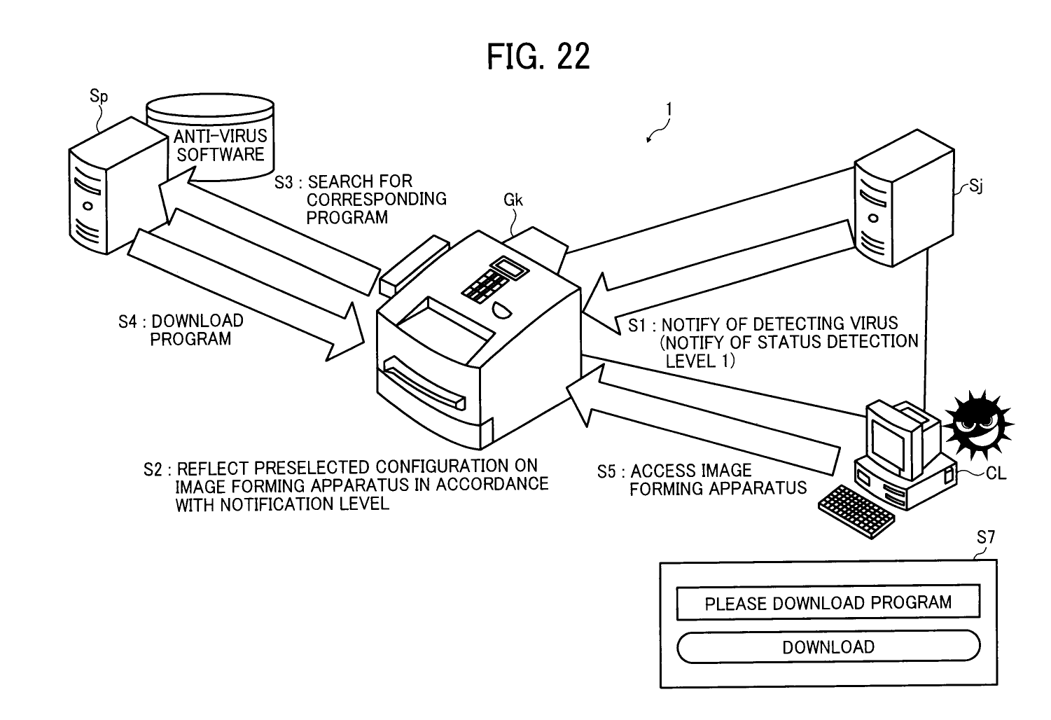

In addition, in the image processing system 1, if the image forming apparatus Gk is configured to notify of downloading a program and the condition management server Sj detects computer virus as shown in FIG. 22, the image forming apparatus Gk is notified of the status change notification of detecting the computer virus in S1. In FIG. 21, it should be noted that same numbers are assigned to processes same as in FIG. 17.

In response to the status change, in the image forming apparatus Gk, the image forming apparatus Gk is configured with a preselected operational configuration in accordance with the status change in S2.

In addition, in accordance with the configuration in the initialization process, the image forming apparatus Gk searches for a program corresponding to the status change such as anti-virus program etc. through the program server Sp in S3, and the program is downloaded from the program server Sp in S4.

Next, in the image forming apparatus Gk, the downloaded program is stored as a program management list Lp as shown in FIG. 21 in the secondary memory 16.

After that, if there is access from the client terminal CL in S5, the image forming apparatus Gk notifies of downloading a program and display a screen that indicates a download button etc. and messages such as “Please download program” etc. on the display of the client terminal CL to attract user attention. In the displayed screen, it is prompted to download a program by user operation by displaying the screen on which user operation other than downloading the program cannot be performed.

Furthermore, as described above, in the image processing system 1, if the condition management server Sj notifies the image forming apparatus Gk of the status change notification such as detection of computer virus and the image forming apparatus Gk is configured to accept the status change notification in the initialization process, the image forming apparatus Gk receives the status change notification. The image forming apparatus Gk performs operational configuration and access handling selected in the initialization process in accordance with the received status change notification.

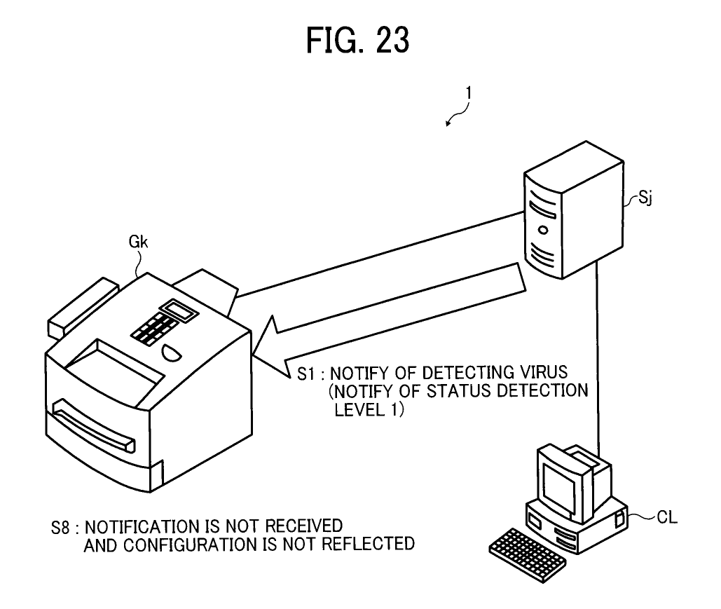

If the image forming apparatus Gk is configured to reject the status change notification in the initialization process, as shown in FIG. 23, the image forming apparatus Gk rejects the status change notification such as detection of computer virus sent from the condition management server Sj. As a result, the image forming apparatus Gk is not configured with a configuration corresponding to the status change notification.

As described above, in the image processing system 1 in this embodiment as an information processing system, at least the client terminal (terminal) CL, the image forming apparatus (apparatus) Gk, and the condition management server (status management apparatus) Sj are connected to the network NW, the image forming apparatus Gk performs various operational processes in response to access from the client terminal CL, and the condition management server Sj detects network status change NW including the client terminal CL. The condition management server Sj includes a communication function unit (communication unit) 61 that communicates with the client terminal CL and the image forming apparatus Gk via the network NW, a detection function unit (detection unit) 62 that detects network status change NW including the client terminal CL, and a notification function unit (notification unit) 63 that notifies the image forming apparatus Gk of the status change information via the communication function unit 61. The image forming apparatus Gk includes a communication function unit (communication unit) 31 that communicates with the client terminal CL and the condition management server Sj via the network NW, initial configuration information initialized as an operational configuration in an operational process, a configuration information storing function unit (configuration information storing unit) 33 that stores changed status configuration information that indicates operational configuration corresponding to the status change information reported by the condition management server Sj, a configuration modifying function unit (configuration modifying unit) 32 that modifies current operational configuration based on the initial configuration information, and an operation control function unit (control unit) 34 that controls operational processes based on the operational configuration.

Consequently, if the status change including security statuses such as infection by computer virus etc. occurs in the network NW including the client terminal CL, the operational configuration of the image forming apparatus Gk is modified in accordance with the changed status. As a result, it is possible to cope with the status change of the network NW including security effectively.

In addition, the image forming apparatus Gk in this embodiment as an image forming apparatus is connected to the network NW with at least the client terminal (terminal) CL and the condition management server (status management apparatus) Sj. The image forming apparatus Gk performs various operational processes in response to access from the client terminal CL, and the condition management server Sj detects network status change NW including the client terminal CL and notifies the image forming apparatus Gk of the detection result of the network NW. The image forming apparatus Gk includes a communication function unit (communication unit) 31 that communicates with the client terminal CL and the condition management server Sj via the network NW, initial configuration information initialized as operational configuration in operational process, a configuration information storing function unit (configuration information storing unit) 33 that stores changed status configuration information that indicates operational configuration corresponding to the status change information reported by the condition management server Sj, a configuration modifying function unit (configuration modifying unit) 32 that modifies current operational configuration based on the initial configuration information, and an operation control function unit (control unit) 34 that controls operational processes based on the operational configuration.

Consequently, if the status change including security statuses such as infection by computer virus etc. occurs in the network NW including the client terminal CL, the operational configuration of the image forming apparatus Gk is modified in accordance with the changed status. As a result, it is possible to cope with the status change of the network NW including security effectively.

In the image processing system 1 in this embodiment, the configuration information storing function unit 33 stores at least access control configuration information for controlling access to data in a target to be processed in an operation and user identification control configuration information for controlling user identification in using the image forming apparatus Gk as the apparatus. The configuration modifying function unit 32 modifies either the current access control configuration, the user identification control configuration, or both based on one or more of the initial configuration information, the status change information, the access control configuration information as the changed status configuration information in the configuration information storing function unit 33, and the user identification control configuration information.

Consequently, if the status change including security statuses such as infection by computer virus etc. occurs in the network NW including the client terminal CL, either the access control configuration or the user identification control configuration, or both, are modified in accordance with the changed status. As a result, it is possible to prevent data from being tampered, removed, and deleted and prevent the image forming apparatus Gk from being interfered. Therefore, it is possible to improve security further.

In the image processing system 1 in this embodiment, the detecting function unit 62 detects the security status change such as infection by computer virus, the configuration information storing function unit 33 stores program acquisition configuration information that indicates an operation of acquiring an anti-virus program for removing the computer virus, and the configuration modifying function unit 32 changes the operational configuration into an operational configuration for acquiring an anti-virus program corresponding to the reported virus infection information based on the initial configuration, the virus infection information as the status change information, and the program acquisition configuration information as the changed status configuration information in the configuration information storing function unit 33.

Consequently, if the status change including security statuses such as infection by computer virus etc. occurs in the network NW including the client terminal CL, the operational configuration of the image forming apparatus Gk is modified so that the anti-virus program for removing the computer virus is acquired (downloaded) in accordance with the changed status. As a result, in case of being infected by computer virus, it is possible to acquire an anti-virus program and cope with the situation. Therefore, it is possible to improve security further.

Furthermore, in the image processing system 1 in this embodiment, the detecting function unit 62 detects security status change such as infection by computer virus, the configuration information storing function unit 33 stores program acquisition prompting configuration information that indicates an operation of prompting to acquire an anti-virus program for removing the computer virus as the changed status configuration information, and the configuration modifying function unit 32 modifies the operational configuration to notify the accessing client terminal CL that the client terminal CL is infected by the computer virus and it is prompted to acquire the anti-virus program based on the initial configuration information, the virus infection information as the status change information, and the program acquisition prompting configuration information as the changed status configuration information in the configuration information storing function unit 33.

Consequently, if the status change including security statuses such as infection by computer virus etc. occurs in the network NW including the client terminal CL, the operational configuration of the image forming apparatus Gk is modified so that the client terminal CL is prompted to acquire (download) the anti-virus program for removing the computer virus in accordance with the changed status. As a result, in case of being infected by computer virus, it is possible to have the client terminal CL acquire an anti-virus program and cope with the computer virus. Therefore, it is possible to improve security further.

In addition, in the image processing system 1 in this embodiment as an information processing system, at least the client terminal (terminal) CL, the image forming apparatus (apparatus) Gk, and the condition management server (status management apparatus) Sj are connected to the network NW, the image forming apparatus Gk performs various operational processes in response to access from the client terminal CL, and the condition management server Sj detects network status change NW including the client terminal CL. The image forming apparatus Gk includes a communication function unit (communication unit) 61 that communicates with the client terminal CL and the condition management server Sj via the network NW, initial configuration information initialized as operational configuration in operational process, a configuration information storing function unit (configuration information storing unit) 33 that stores changed status configuration information that indicates operational configuration corresponding to the status change information reported by the condition management server Sj, a configuration modifying function unit (configuration modifying unit) 32 that modifies current operational configuration based on the initial configuration information, the status change information received by the communication function unit 61, and the changed status configuration information stored in the configuration information storing function unit 33, and an operation control function unit (control unit) 34 that controls operational processes based on the operational configuration.

Consequently, if the status change including security statuses such as infection by computer virus etc. occurs in the network NW including the client terminal CL, the operational configuration of the image forming apparatus Gk is modified in accordance with the changed status. As a result, it is possible to cope with the status change of the network NW including security effectively.

The present invention also encompasses a non-transitory recording medium storing a program that executes a setting status management method, performed by an information processing system. The setting status management method, performed by the information processing system, includes the steps of connecting a terminal, the apparatus, and the status management apparatus to a network, gaining access from the terminal to perform various operational processes, detecting status change of the network including the terminal, communicating with the terminal and the apparatus via the network, detecting network status change including the terminal, notifying the apparatus of status change information via the communication unit, communicating with the terminal and the status management unit via the network, initializing initial configuration information as an operational configuration in an operational process, storing changed status configuration information that indicates the operational configuration corresponding to the status change information reported by the status management apparatus, modifying a current operational configuration based on the initial configuration information, the status change information, and the changed status configuration information after receiving the status change information, and controlling an operational process based on the operational configuration.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. An information processing system, comprising:
a terminal;
an apparatus configured to gain access from the terminal to perform various operational processes; and
a status management apparatus,
the status management apparatus comprising:
a communication unit to communicate with the terminal and the apparatus via a network;
a detection unit to detect network status change including the terminal via the communication unit; and
a notification unit to notify the apparatus of status change information via the communication unit,
the apparatus comprising:
a communication unit to communicate with the terminal and the status management unit via the network;
initial configuration information initialized as an operational configuration in an operational process;
a configuration information storing unit to store changed status configuration information that indicates the operational configuration corresponding to the status change information reported by the status management apparatus;
a configuration modifying unit to modify a current operational configuration based on the initial configuration information, the status change information, and the changed status configuration information in the configuration information storing unit after the communication unit receives the status change information; and
a control unit to control one or more operational process executed by the information processing system based on the operational configuration.

2. The information processing system according to claim 1, wherein:
the configuration information storing function unit stores at least access control configuration information for controlling access to data in a target to be processed in an operation and user identification control configuration information for controlling user identification in using the apparatus as the changed status configuration information; and
the configuration modifying function unit modifies either the current access control configuration, the current user identification control configuration, or both, based on one or more of the initial configuration information, the status change information, the access control configuration information, and the user identification control configuration information as the changed status configuration information in the configuration information storing function unit.

3. The information processing system according to claim 1, wherein:
the detection unit detects security status change such as infection by computer virus as the status change;
the configuration information storing function unit stores program acquisition configuration information that indicates an operation of acquiring an anti-virus program for removing the computer virus as the changed status configuration information; and
the configuration modifying function unit changes the operational configuration into an operational configuration for acquiring an anti-virus program for removing the computer virus based on the initial configuration, the virus infection information as the status change information, and the program acquisition configuration information as the changed status configuration information in the configuration information storing function unit.

4. The information processing system according to claim 1, wherein:
the detection unit detects security status change such as infection by computer virus as the status change;
the configuration information storing function unit stores program acquisition prompting configuration information that indicates an operation of prompting to acquire an anti-virus program for removing the computer virus as the changed status configuration information; and
the configuration modifying function unit modifies the operational configuration to notify the accessing terminal that the terminal is infected by the computer virus and it is prompted to acquire the anti-virus program based on the initial configuration information, the virus infection information as the status change information, and the program acquisition prompting configuration information as the changed status configuration information in the configuration information storing function unit.

5. The information processing system according to claim 1, wherein the apparatus is an image forming apparatus.

6. A setting status management method for an information processing system, comprising:
connecting a terminal, an apparatus, and a status management apparatus to a network;
gaining access from the terminal to perform various operational processes;
communicating with the terminal and the apparatus via the network;
detecting network status change including the terminal;
notifying the apparatus of status change information via the communication unit;
communicating with the terminal and the status management unit via the network;
initializing initial configuration information as an operational configuration in an operational process;
storing changed status configuration information that indicates the operational configuration corresponding to the status change information reported by the status management apparatus;
modifying a current operational configuration based on the initial configuration information, the status change information, and the changed status configuration information after receiving the status change information; and
controlling one or more operational process executed by the information processing system based on the operational configuration.

7. An apparatus connected to a terminal and a status management apparatus through a network and configured to gain access from the terminal to perform various operational processes, the apparatus comprising:
a communication unit to communicate with the terminal and the status management unit via the network and to receive status change information from the status management unit in response to detecting network status change;
initial configuration information initialized as an operational configuration in an operational process;
a configuration information storing unit to store changed status configuration information that indicates the operational configuration corresponding to the status change information reported by the status management apparatus;
a configuration modifying unit to modify a current operational configuration based on the initial configuration information, the status change information, and the changed status configuration information in the configuration information storing unit after the communication unit receives the status change information; and
a control unit to control one or more operational processes executed by the apparatus based on the operational configuration.
